(19) United States
(12) Patent Application Publication
(10) Pub. No.: US 2020/0311661 A1
(43) Pub. Date: Oct. 1, 2020

(54) INTEGRATED SYSTEM AND METHOD FOR MANUFACTURING, CATEGORIZING, AND DISPENSING EYEGLASSES

(71) Applicants: Robert Wesley Stein, Cumming, GA (US); NATIONAL VISION, INC., Duluth, GA (US)

(72) Inventor: Robert Wesley Stein, Cumming, GA (US)

(21) Appl. No.: 16/756,798

(22) PCT Filed: Oct. 15, 2018
(86) PCT No.: PCT/US18/55814

§ 371 Date: Apr. 16, 2020

Related U.S. Application Data
(60) Provisional application No. 62/572,638, filed on Oct. 16, 2017.

(51) Int. Cl. G06Q 10/08; G02C 13/00; B24B 9/14; B24B 13/005

(52) U.S. Cl. CPC G06Q 10/087; G02C 13/005; B29D 11/00942; B24B 13/0055; B24B 9/148

(57) ABSTRACT

Implementations of a system for the manufacture of eyeglasses is disclosed. The system includes a lens-mounting block, a lens blank coupled to the lens-mounting block, a lens coupled to the lens blank, and an edger. The edger follows a perimeter of the lens-mounting block to edge a perimeter of the lens. The lens blank detaches from the lens-mounting block after the lens is edged.

### CROSS-REFERENCE TO RELATED APPLICATION

The present application is a 35 U.S.C. § 371 national stage application of PCT International Patent Application Serial No. PCT/US2018/055814, filed on Oct. 15, 2018, which claims priority to U.S. Provisional Application Ser. No. 62/572,638 filed on Oct. 16, 2017. The entire contents of which are incorporated herein by reference in their entireties.

### BACKGROUND

### 1. Field of the Invention

The present disclosure relates generally to an integrated system for the selection and distribution or manufacturing of eyeglasses.

### 2. Related Art

This section provides background information related to the present disclosure that is not necessarily prior art.

Myopia, or nearsightedness, in human eyes is increasing at an epidemic rate and logistics of care and solution delivery are a major hurdle in solving this problem. Uncorrected Refractive Error (URE) affects roughly 700 million people globally. When refractive errors are not corrected or when the correction is improper, they can cause severe visual impairment and even blindness. This issue exists in all countries, but primarily in developing world countries, stemming from poverty, lack of qualified optometrists & clinicians, and a lack of affordable solutions.

This problem is being addressed with a wide variety of efforts, but much of this is in a “one-up” setting that is not sustainable or easily replicated. Much of the work in this area centers on the acquisition of equipment or product for each mission or outreach without access to a consistent supply chain or methodology. At the same time, there are tremendous wasted optical resources that go untapped due to lack of industry collaboration or supporting data.

In most cases, the major hurdle to success is logistics. Such logistics include the acquisition of product to deliver, identifying sustainable service points or locations, providing the clinical or medical services needed, consistent methodology of care delivery that can allow other ecosystem factions to support effectively, and the creation of educational materials and certification of optical professionals and para professionals. Furthermore, the lack of reliable data impedes progress in addressing all of the logistics barriers.

Currently, there is no current universal “standard of optical mission care” that can allow for a common delivery method and data capture/exchange. This disclosure is a Point of Sale (POS) software system that reinforces one dynamic & flexible delivery methodology. This system can allow for a global optical data exchange via a secure site on the internet and for a sustainable supply chain to be created to support the delivery of low cost eyewear to those in need. This solution includes the use and dispensing of pre-made (new) eyeglasses, pre-made custom eyeglasses assembly kits, custom manufactured eyeglasses, including both on-site limited manufacturing and off-site full scope manufacturing, and surgical solutions.

Optical lens manufacturing essentially uses finished or semi-finished lenses based upon the optical needs in order to address any refractive error need. Although ideal, this increases the complexity of lens manufacturing exponentially. This disclosure addresses the largest possible level of need without the related complexity increase, realizing that a balance point must be struck.

Near vision correction, distance vision correction and astigmatic vision correction can be addressed by this formula within limits that are driven by lens inventory. The resulting eyeglasses will be custom and take all components of the Rx (including a binocular PD (Pupillary Distance), which is the measurement of both eyes) into account. The optical manufacturing system of this disclosure facilitates low cost, low technology optical manufacturing that is portable and services a wide variety of prescription needs.

The essential lens functionality in terms of refracting light does not change from existing lenses. The lens material can be a material such as CR39, polycarbonate, or acrylic depending on cost estimates and limitations. A limitation of the traditional methods of manufacturing eyeglasses is complicated by the concept of edging lenses and the number of steps performed before edging the lenses can be performed. Traditionally, a lens is removed from an envelope. Either automated or manual equipment is then used to find the optical center and horizontal alignment and determine the decentration based upon the binocular PD, or Pupillary Distance, and the varying frame design. A spot up (mark) is made on the lens, a mounting block is attached to the lens, and then the edging step is done to remove excess lens material. Edging either uses a computer tracing of the frame or a precut guide in order to cut the lens shape and edge design. The present disclosure uses a two-step process of 1) mounting directly onto the block and 2) edging to that block.

This system is based on the creation and use of set components of a kit that work in concert with each other to remove steps and barriers from the production of a pair of eyeglasses. Eyeglass frames, or frames, with very specific lens shapes will need to be designed and manufactured. Multiple lens shapes would be limited by how large the kit would be, but can be any reasonable number. The frame designs can and should exceed the number of lens shapes by a multiple to allow for greater selection and patient satisfaction. Unlike traditional eyeglass methods and designs, one lens shape of this disclosure will fit multiple frames.

### SUMMARY

This section provides a general summary of the present disclosure and is not a comprehensive disclosure of its full scope or all of its features, aspects, and objectives.

Disclosed herein are implementations of a system for the manufacture of eyeglasses. The system includes a lens-mounting block, a lens blank coupled to the lens-mounting block, a lens coupled to the lens blank, and an edger. The edger follows a perimeter of the lens-mounting block to edge a perimeter of the lens. The lens blank detaches from the lens-mounting block after the lens is edged.

Also disclosed herein are implementations of a method for the manufacture of eyeglasses. The method includes aligning a lens blank having a lens decal design printed or adhered on the axis and center of the lens blank onto a lens-mounting block, mounting (adhering) the lens to the lens-mounting block, and edging a perimeter of the lens based on a perimeter of the lens-mounting block.

Also disclosed herein are implementations of a computer-implemented method for the manufacture of eyeglasses, comprising receiving, from a computing device, a dataset in a first format; transforming the dataset into a second format; evaluating the dataset and computing a score for eyeglasses in the dataset; ranking eyeglasses by applying a weight factor to the score to create a ranked result set; and providing the ranked result set to a visualizer.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1-8 are modules of the user interface in accordance with the present disclosure.

FIGS. 9-10 are forms used for the selection of eyeglasses in accordance with the present disclosure.

FIGS. 11-13 are modules of the user interface in accordance with the present disclosure.

FIGS. 14a and 14b are a front view of a spherical lens mounting decal in accordance with the present disclosure.

FIGS. 15a-15c are an exploded view of a lens-mounting block in accordance with the present disclosure.

FIGS. 16a-16f are an exploded view of illustrate a spherocylindrical (astigmatic) lens alignment in accordance with the present disclosure.

FIGS. 17a and 17b are perspective views of a lens-mounting block in accordance with the present disclosure.

FIGS. 18a and 18b are front views of a lens decal in accordance with the present disclosure.

FIG. 18c is an image of a pair of lenses in in accordance with the present disclosure.

FIG. 19a is a perspective view of a lens blocker machine in accordance with the present disclosure.

FIG. 19b is an adhesive for use with the lens blocker machine.

FIG. 20 is a partial image of a lens blocker machine in accordance with the present disclosure.

FIG. 21 is a partial image a lens alignment grid in accordance with the present disclosure.

FIG. 22 is a block diagram of a system for transforming, measuring, and ranking the patient's eyeglass specifications to available eyeglasses in accordance with the present disclosure.

### DETAILED DESCRIPTION

This disclosure includes a system to creating an ecosystem for improving eye patient care. The ecosystem has four main components: 1) a point of sale (POS) and lab system, 2) global data collection, 3) universal method and support, and 4) creating a supply chain.

The POS and lab system can include a patient care and Uncorrected Refractive Error (URE) solution delivery, a common method, a data capture, global sharing, and inventory control. Using a user interface for naming and/or identification can allow for multiple missions across multiple organizations to use the same database. The comprehensive POS system can include patient history, screening & exam results, and solution selection tool. The solution selection tool can further include algorithms that select best match pre-made eyeglasses based on current Rx, age, ocular accommodative ability, gender and child or adult frames, on-site manufacturing tracking system, as well as “assemble on site” eyeglasses kits, and planned off-site manufacturing orders via paper documents or electronic ordering. The POS system can allow a user to select the above-identified categories or additional categories or sections and enter in patient information into the appropriate sections. The user can save the information and/or exit the program/window.

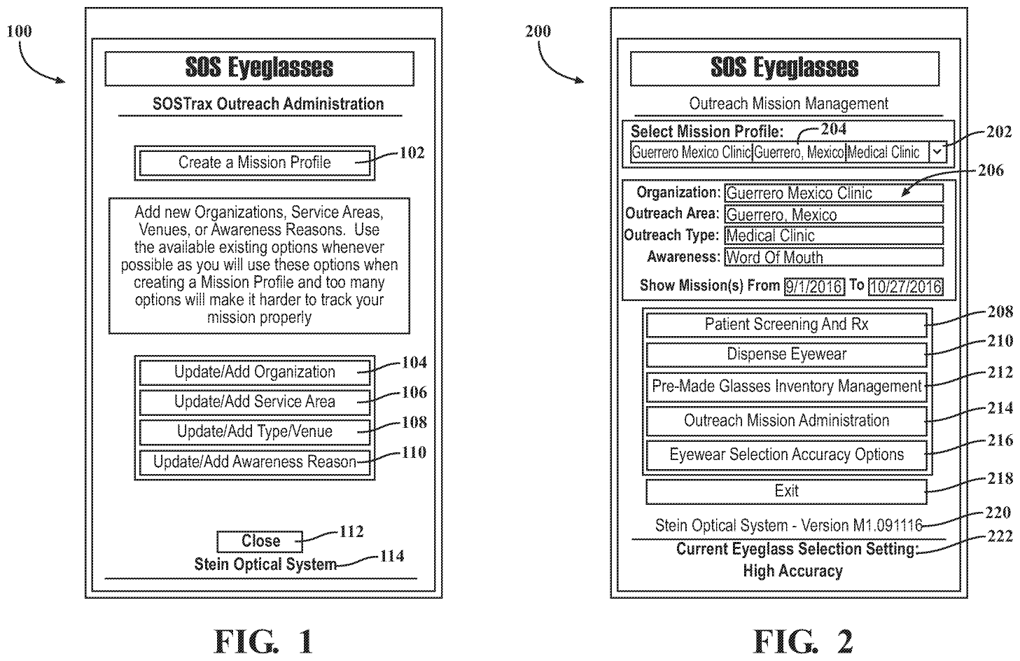

Referring to FIG. 1, module 100 illustrates an example of a home page or administration module of the POS user interface. The user can add or update new organizations, service areas, venues, and/or awareness reasons. The user can select a button 102 to create a mission profile, a button 104 to update/add an organization, a button 108 to update/add a type/venue, a button 110 to update/add an awareness reason, or a button 112 to close the program/software/module. The user can use the available exiting options whenever possible to create a mission profile so that the user can properly track its mission. The module 100 can also display a name of a system 114. For example, the name of the system 114 is “Stein Optical System.”

Referring to FIG. 2, module 200 illustrates an example of a management module of the POS user interface. After a user selects the button 102 on model 100 to create a mission profile, module 200 is displayed. The module 200 includes a dropdown arrow 202 that a user can select to display a dropdown menu of mission names to select. Once a name is selected, the name may appears in a text box 204. A user can manually add additional information about the organization into the organization section 206 by first selecting a button 104 from the module 100. For example, information can be added for the organization name, outreach area, outreach type, awareness, and mission dates. The information can automatically be entered when the mission name is selected if the information was previously added to the database, for example, by selecting an appropriate button on module 100 and adding the information when prompted by the system. The user can navigate the POS user interface by selecting a menu option, or button, to access additional modules. The user can select a button 208 to add/access patient screening and Rx, a button 210 to add/access dispense eyewear information, a button 214 to add/access pre-made eyeglasses inventory administration information, a button 216 to add/access eyewear selection accuracy options, or a button 218 to close or exit the module 200. If the user selects the button 218, the module 200 can be exited and module 100 can be displayed. Alternatively, other modules, pages, or prompts of the user interface can be displayed. The version of the software of the POS user interface can be displayed as version 220. A current eyeglass selection setting 222 can display the level of accuracy, such as high accuracy.

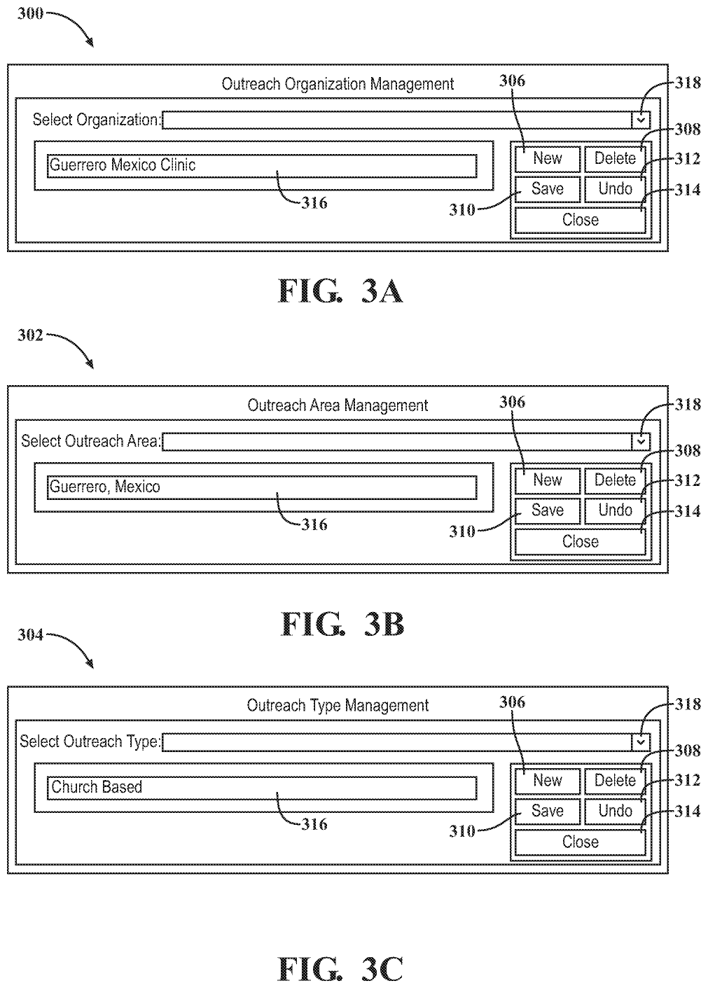

FIGS. 3a, 3b, and 3c, modules 300, 302, and 304 illustrate example modules of the POS user interface that are displayed after a user selects the buttons 104, 106, or 108 on model 100 to update/add an organization, a service area, or a type/venue, respectively. New information can be added to modules 300, 302, and 304 by selecting a button 306, deleted by selecting a button 308, saved by selecting a button 310, undone by selecting a button 312, and closed by selecting a button 314. The user may type information directly into a text box 316. Alternately, the user can select a dropdown arrow 318 for a dropdown list of data to select from. After information is added to text box 316, the user can select a button 310 to save the text. The text may be listed in the dropdown list when dropdown arrow 318 is selected. FIG. 3a illustrates an example of an outreach organization management display. FIG. 3b illustrates an example of an outreach area management display. FIG. 3c illustrates an example of an outreach type management display.

The global data collection may contain specific patient data for funding, research, and product sourcing that can be stored on a secure website. Valid data collection and open accessibility for data may allow for coordinated research and funding, increased partnerships, and a growth of the URE supply chain (e.g., frames, lenses, and pre-made eyeglasses).

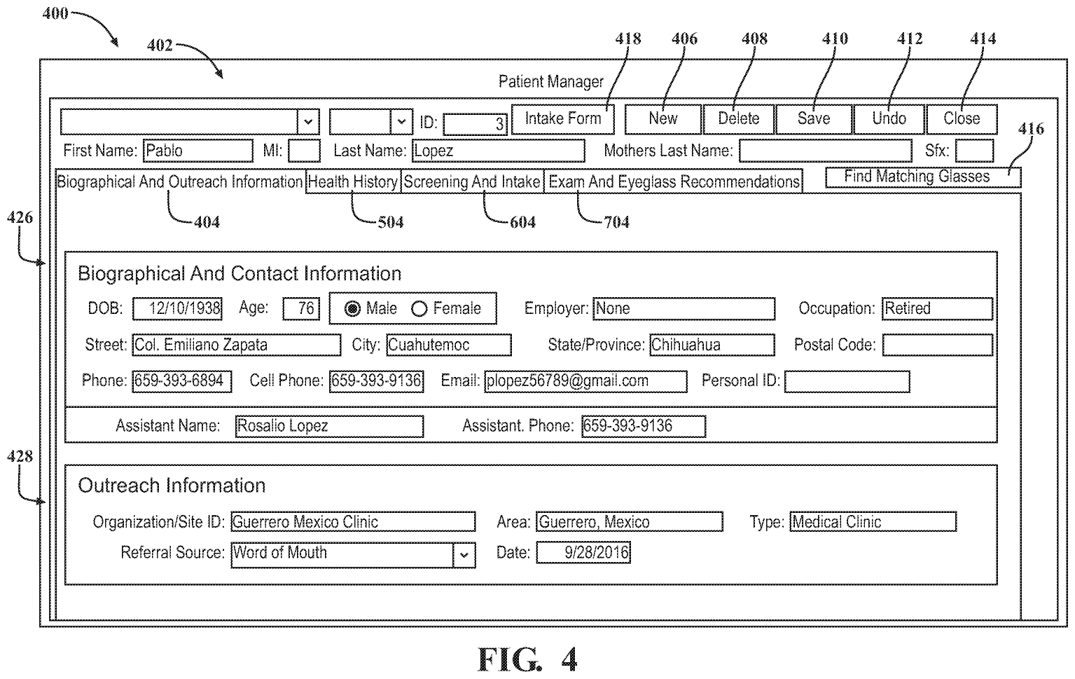

FIG. 4 illustrates a module 400 that is an example of a patient manger module that includes a patient manager 402 for providing patient information to be added or displayed in the module 400. Such information can include an identification number box (ID box), a first name box, a middle initial box (MI box), a last name box, a mother's last name box, and a suffix box (Sfx box). The information can be displayed in text boxes or from dropdown arrow selections, or by other means. The module 400 further includes menu options that the user can select, such as a button 406 for a new patient, a button 408 to delete the patient or patient information, a button 410 to save the patient information to the database, a button 412 to undo the last action performed by the user, a button 414 to close module 400, a button 416 to find matching eyeglasses, and a button 418 for an intake form. The module 400 can also include various tabs including a tab 404 for biographical and outreach information, a tab 504 for health history, a tab 604 for screening and intake, and a tab 704 for an exam and eyeglass recommendations. Patient manager 402 is a patient manager module that can be displayed when the tabs 404, 504, 604, and 704 are selected and displayed. The tabs 420, 422, and 424 will be described in more detail in this disclosure.

Displayed in tab 404 for biographical and outreach information are a section 426 for biographical and contact information and a section 428 for outreach information. The section 426 can include text boxes or radio buttons for the user to fill in patient information, for example but not limited to the patient's date of birth, age, gender, employer, occupation, address, phone numbers (home, mobile, work, or other), email address, personal identification, and any other desirable information. Text boxes can also be available to add and display an assistant's name and phone number. The section 428 includes, for example but not limited to, an organization/site identification name or number, its area, type, referral source, the date, and any other desirable information. Such information can be filled in, edited, selected from a dropdown arrow, or inserted from the database.

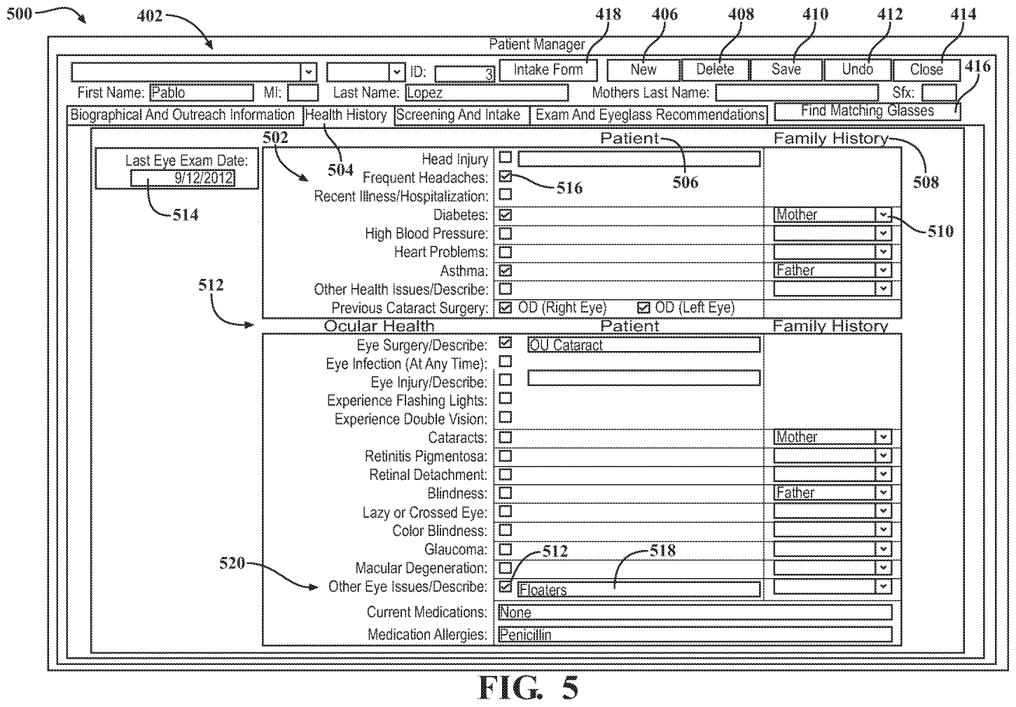

Referring to FIG. 5, a module 500 can display the patient manager 402 of providing patient information and the tab 504 for adding and displaying health history of the patient and the family history of the patient. Such information can include both a section 502 for adding general health information and a section 512 for adding ocular health information. The information can be input into the program using check boxes, dropdown boxes, text boxes, or any other desirable function. For example, a check box 516 can be selected by a user to display a check next to text “Frequent Headaches” to indicate that the patient has headaches frequently. Alternatively, a check can be added to the check box automatically when text is added to the corresponding text box or by the software depending on the information stored in the database. For example, the user types “Floaters” in a text box 518 next to a text 520 displaying “Other Eye Issues/Describe” and a check in a check box 522 automatically appears. In a section 508 for family history information, a dropdown arrow 510 can be selected by a user to choose a member of the patient's family, such as mother, father, brother, sister, grandmother, grandfather, child, or any other desirable family member. Other options may be available. In addition, a text box 514 can be displayed for the user to enter the date of the patient's last eye exam.

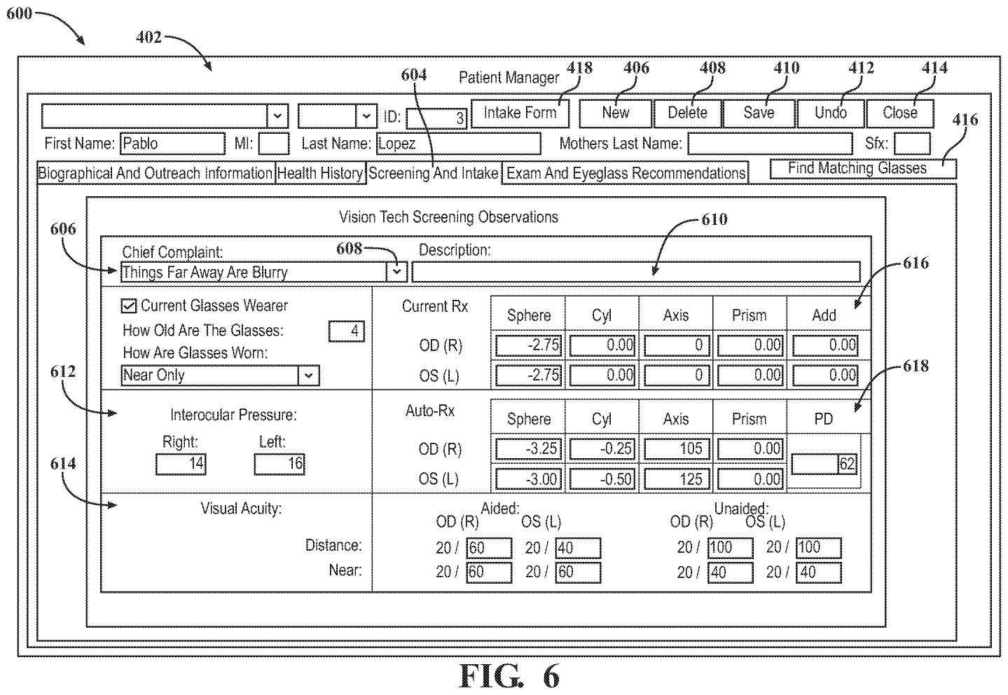

FIG. 6 illustrates a model 600 of patient manager 402 displaying the tab 604 for screening and intake and includes vision tech screening observations. A section 606 with information pertaining to the patient's chief vision complaint can be displayed. A dropdown box 608 can be selected by the user to identify the main reason for the patient's eye exam. The user can enter additional information, such as a description, into a text box 610. The tab 604 can allow the user to further supplement the section 606, including whether the patient currently wears eyeglasses, the age of the eyeglasses, the type of eyeglasses, and other desirable information. The user can also enter information from the previous eye exam prescription and/or preliminary information. For example, such information can include a section 612 for interocular pressure of the right and left eyes, a section 616 for a current prescription (Rx) of the patient's eyes and/or lenses, a section 618 for an auto-Rx, and a section 614 for the patient's visual acuity. For the current Rx and the Auto-Rx in sections 616 and 618, text boxes may be available for adding the following information: sphere, cylinder, axis, prism, and add power for the current Rx or the binocular PD of the auto-Rx for both the right and the left (except for the binocular PD, which is only one combined value). The information in section 614 of the visual acuity can include text boxes for both distance and near of the right and left eyes with and without corrective aid (e.g. of contact lenses or the lenses of eyeglasses, or the lenses used in the vision machine).

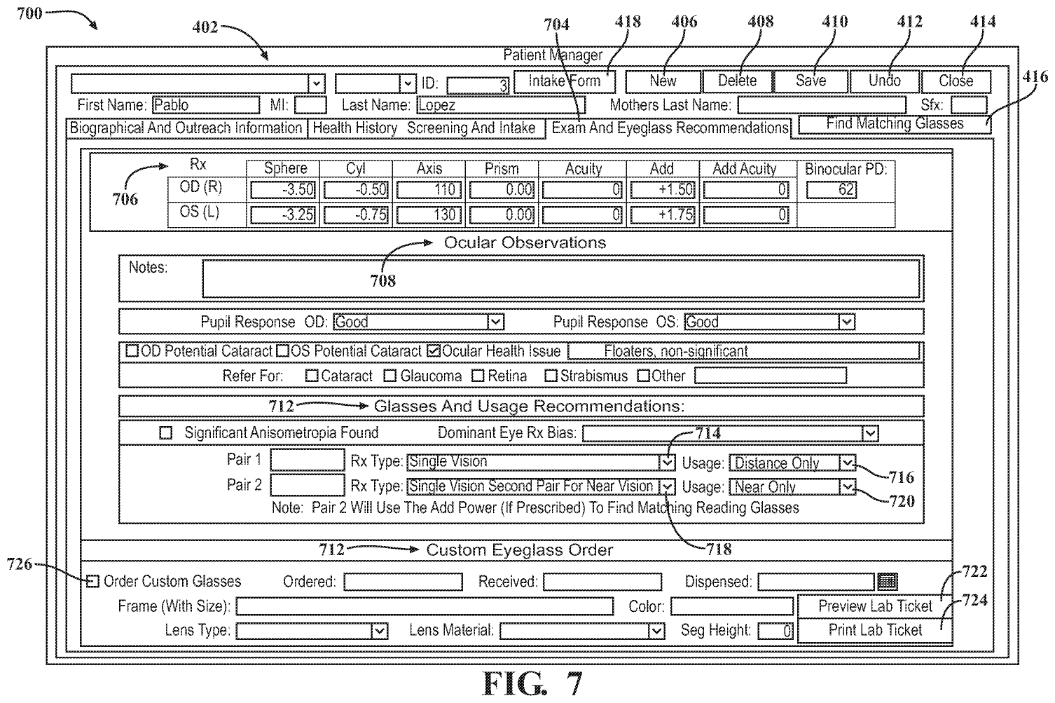

FIG. 7 illustrates a model 700 of patient manager 402 displaying the tab 704 for exam and eyeglass recommendations. The tab 704 can include a section 706 for prescriptions (Rx), a section 708 for ocular observations, a section 710 for eyeglasses and usage recommendations, and a section 712 for a custom eyeglass order. The section 706 can include the patient's new eyeglass prescription information. Text boxes can be used to enter in the sphere, cylinder, axis, prism, acuity, add, add acuity, and binocular PD for both the right and left eyes. The information may be entered by the user or the information may be auto-generated based on the prescription information stored in the database or added in another module, such as tab 604 for the screening and intake. The user can enter notes in the section 708 for any ocular observations, as well as select the pupil response for each eye and select or enter text for various other eye-related conditions. Additionally, the section 708 can contain information for the user to select to refer the patient to another doctor who specializes in areas relating to cataracts, glaucoma, retina, strabismus, or other vision issues.

The section 710 for eyeglasses and usage recommendations may allow a user to select a check box if significant anisometropia is found and/or select a dropdown arrow for a dominant eye Rx bias. The user can select an Rx type for a first pair of eyeglasses/lenses using a dropdown arrow 714 for the type of prescription, such as single vision, and a dropdown arrow 716 for the type of usage, such as distance only. The user can select an Rx type for a second pair of eyeglasses/lenses using a dropdown arrow 718 for the type of prescription, such as single vision second pair for near vision, and a dropdown arrow 720 for the type of usage, such as near only. The second pair can use the add power (if prescribed) to find matching reading eyeglasses. If a patient needs to order custom eyeglasses, the user can enter the patient's information in the section 712. Such information can include when the custom eyeglass order was placed, received, or dispensed by typing in the dates or selecting a calendar icon, which pops up a calendar for a user to select a date to populate a text box.

The user can enter in the frame (with size), color, lens type, lens material, and segment height. The user can select a check box 726 to indicate that custom eyeglasses are or were ordered, or start entering information into the custom eyeglass order section and a check mark will automatically appear in the box. A button 722 for a preview lab ticket can be displayed for a user to select to review the custom eyeglass order information before submitting the order. A button 724 for a print lab ticket can be displayed for a user to select to print the lab ticket. The lab ticket can be printed to a printer, a program, such as a pdf document, or any other desirable device or program.

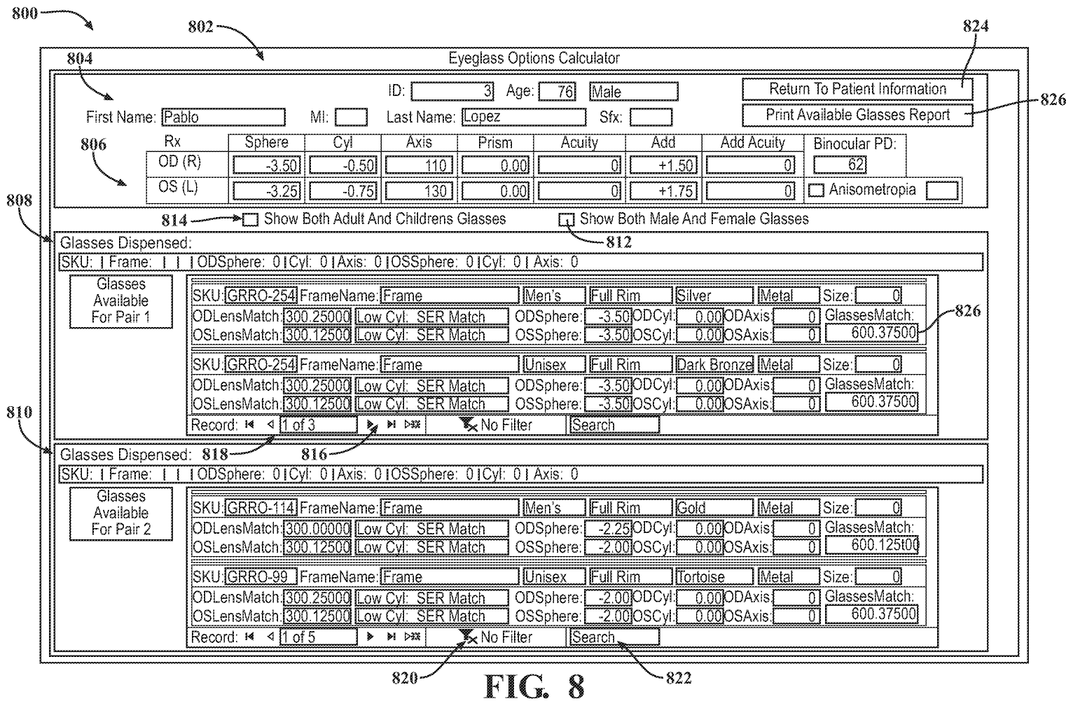

As illustrated in FIG. 8, a module 800 can include an eyeglass options calculator 802 that calculates information obtained from the patient's eye exam and displays eyeglass options and calculations for pre-made eyeglasses. Patient information can be displayed in a section 804 and Rx information can be displayed in a section 806. eyeglasses available for pair 1 can be included in a section 808 and eyeglasses available for pair 2 can be included in a section 810 if Add Power is prescribed. The sections 808 and 810 can also include information, for example, the SKU, frame, as well as the sphere, cylinder and axis for each eye, if available.

The system can provide available eyeglasses (frames and lenses) information that best match the patient's information and the selected information. For example, if the user selects a check box 812 to “show both male and female eyeglasses,” the system can display either or both men and women's frames. The system may also show unisex frames. Selections can be made to show both adult and children's eyeglasses by the user selecting a check box 814. If the system determines that more frames are available that matches the patient's prescription and preferences, the additional frames can be displayed on another page.

The user can select a right arrow 816 or a left arrow 818 to navigate through the pages one page at a time to view additional frame information. The left arrow 818 may be grayed out, which indicates that the user cannot navigate backwards because it is at the first page. Alternatively, if the right arrow 816 is grayed out, it may indicate that the user cannot navigate to additional pages because the user is viewing the last page. The user can select a double right arrow or a double left arrow to navigate to the last or first pages, respectively.

A button 820 can be selected to provide filter guidelines for the software to filter out frames meeting or excluding certain criteria. The user can select a button 824 to return to the patient information. The user can select a button 826 to print the available eyeglasses report.

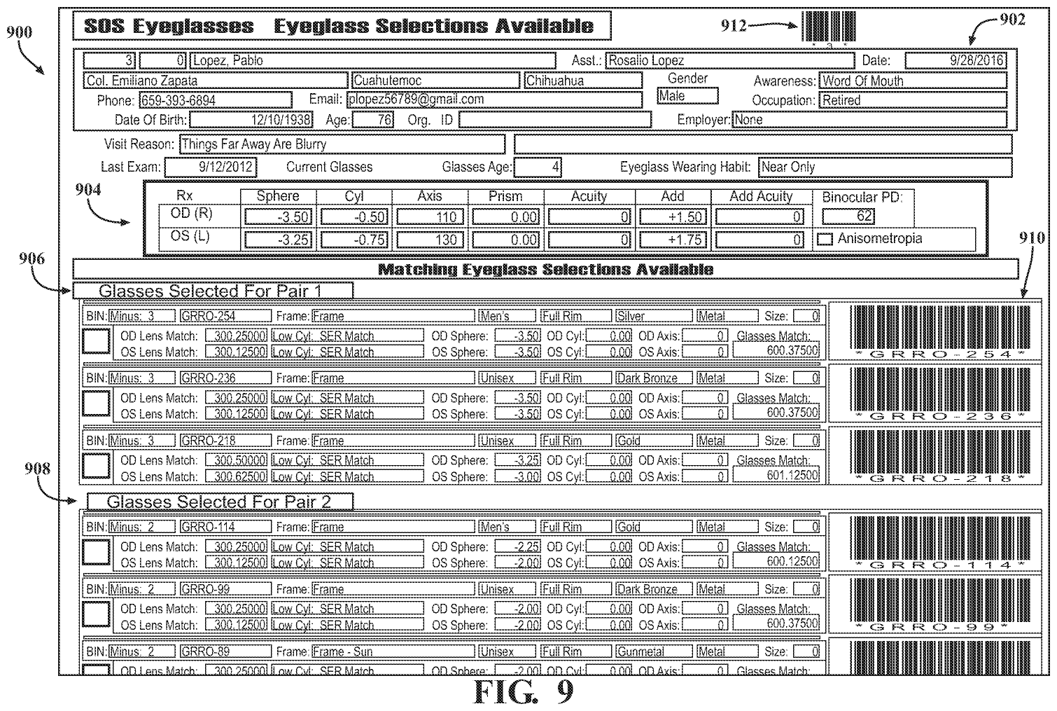

FIG. 9 illustrates a partial sample printout 900 of available eyeglass as identified in FIG. 8. The printout 900 can be used for eyeglass dispensers to distribute the ordered eyeglasses for the patient. The printout may include a section 902 with patient information, a section 904 with prescription information, sections 906 and 908 for matching eyeglass selections available for pairs 1 and 2, respectively, and any other desired information. A bar code 910 can contain SKU information can be included on display next to the eyeglass for scanning the frame information into the system. Another barcode 912 can be included that contains the same, similar, and/or additional information pertaining to the patient and/or the order. Once the order has been completed at the dispensary, the pair or pairs of eyeglasses are removed from inventory.

Pre-made eyeglass considerations can include a unique SKU naming convention. For example, the first four characters are Alpha to indicate manufacturing lab or point of assembly (NVIG—National Vision Inc. Georgia). A unique auto-generated number can be used to represent that specific pair of eyeglasses, for example 14677. This eyeglass can have a SKU of NVIG-14677 that solely represents that specific pair of eyeglasses globally. A bagging/tagging system can be put in place. The SKU, information on male, female, unisex, adult or children's frames, and the sphere, cylinder & axis for both lenses can be clearly visible using the bagging/tagging system. A methodology can be used for the addition/upload of all pre-made eyeglasses. Manual or automatic management of this process within the system can be implemented. The system can automatically decrement inventory upon dispense, but specific reporting makes this process more efficient. The system can be implemented on computers, mobile devices, tablets, devices connected to the world-wide web, or other similar devices capable of implementing the systems of this disclosure.

The custom on-site assembly eyeglasses ecosystem as described in this disclosure can be used to facilitate the assembly and use of eyewear, such as ready to assemble eyewear. A person, such as a laboratory tech or an assembler, snaps in pre-made Rx lenses into the frames (no edging or polishing). This function can use the same lens calculation algorithms to select the lenses to clip into the frame selected by the patient. Tracking available inventory of lenses and frames can be performed, and associated eyeglasses dispensed with the patient. This system can take care of the optical science and allow the dispenser and assembler to follow the instructions on the printout 900 without the need for technical knowledge or training. This creates an additional option to the pre-made eyeglasses selection.

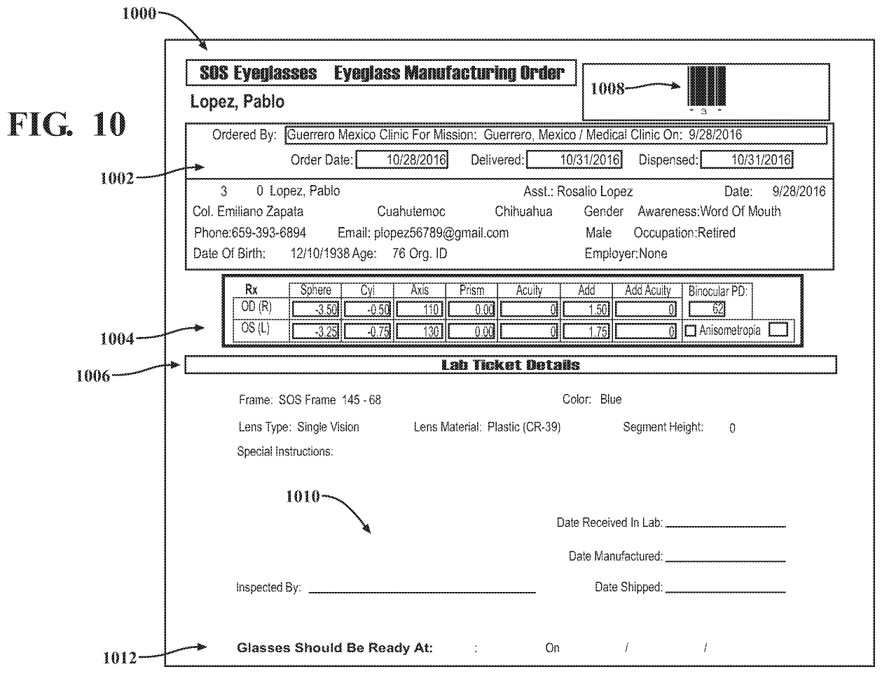

FIG. 10 illustrates a sample printout for a manufacturing order 1000 for eyeglass. The manufacturing order 1000 is a printout of a custom manufacturing ticket, or order, as identified in FIG. 8. This manufacturing order 1000 can be used for a lab to manufacture custom eyeglasses for the patient. The manufacturing order 1000 may include a section 1002 with patient information, a section 1004 with prescription information, a section 1006 with eyeglass order information, such as lab ticket details, and/or any other desirable sections. A bar code 1008 can be included that contains SKU information with the same, similar, and/or additional information pertaining to the patient and/or the order. The information displayed in the section 1006 can include, for example, frame and lens information, special instructions, and a section 1010 for the lab to enter information such as the date the order was received in the lab, the date the eyeglasses was manufactured, the date the eyeglasses was shipped, and who inspected the eyeglasses prior to shipping out. Alternatively, the eyeglasses may be delivered to the patient by another means, such as pickup or hand delivery. The eyeglass manufacturing order can also contain a section 1012 with information for an estimate on when the eyeglasses should be ready.

Supporting and creating the manufacture of custom eyeglasses may be possible using on-site manufacturing and/or remote manufacturing. On-site manufacturing exists in this system using the generated lab tickets, or the manufacturing order 1000. Adding a lens blank inventory can be an additional enhancement to this system. Remote manufacturing can be accomplished by wrapping the jobs in the existing lab ticket. Alternatively, a web-based option where the lab ticket data could be uploaded for a specific lab can be implemented. Using a web-based system improves delivery time and tracking. This system does not need to calculate the job manufacturing parameters, but rather, it can create a universal standard lab ticket/data format for labs irrespective of the specific lab software system of any particular lab.

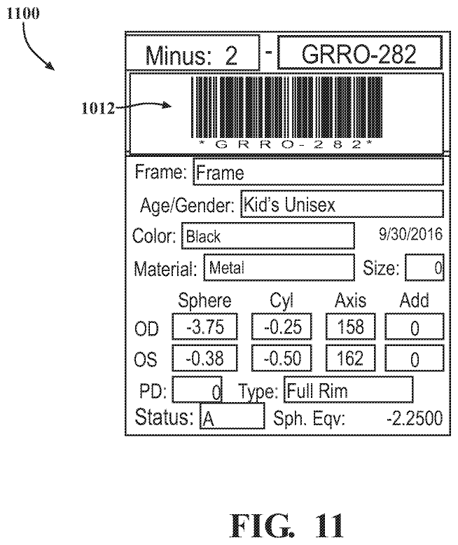

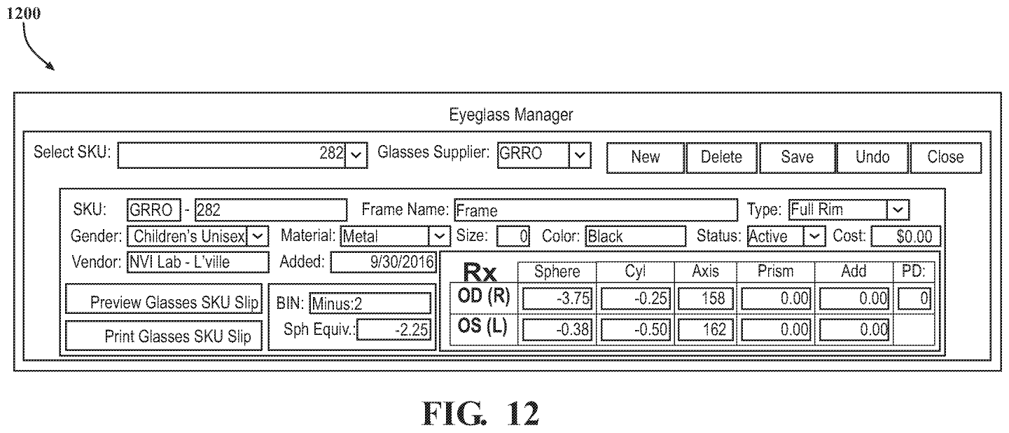

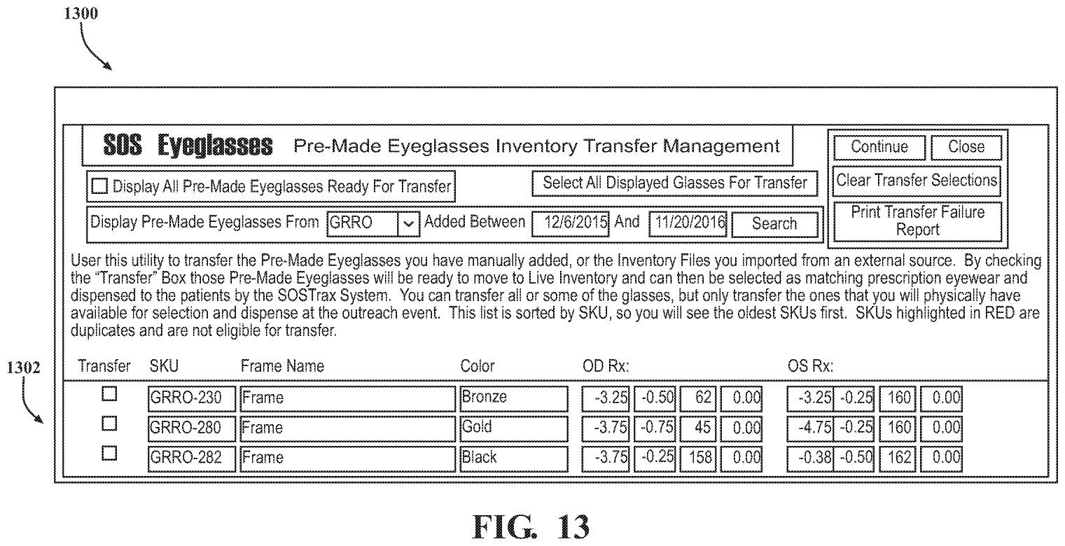

The universal method and support described in this disclosure can include software, online training and support, and access to a related supply chain. The supply chain can be created with data and industry collaboration that allows suppliers to participate sustainably and share information. As illustrated in FIGS. 11-13, using the inventory system of this disclosure may allow for millions of pairs of new, unused eyeglasses that are returned to large retail and wholesale labs to be catalogued by their exact Rx, frame, gender, age category, or any other desirable category. Each pair can be assigned a globally unique bar coded SKU tag or bar code 1102 generated by the inventory system. These can be added manually or merged with the existing lab data (large labs would link to their systems) to produce SKU slips or stickers to go along with the exact pair of eyeglasses. These eyeglasses can then be donated, for example, to a 501(c)(3) distribution center and be tracked accordingly. A module 1300 can be used for inventory management of pre-made eyeglasses. The resulting inventory files can be stored on the secure web site for recall. Each lab, large or small, can contribute to the global need in this way without investing heavily in program development or staffing.

Additionally, the creation of the pre-made eyeglasses ecosystem may allow for eyeglasses to be added to this system. Missions or philanthropic organizations can request specific pre-made inventory based on their needs, for example, using a module 1200, which illustrates a module used for management of eyeglass orders. Inventory and specific details on each pair of eyeglasses can be either scanned in from the bar code 1102, or imported in bulk from the electronic file matching the shipment. A module 1300 can display information in a section 1302 such as a SKU number, frame name, color of the frame, prescription information of the lenses, or any other desirable information. Upon selection and dispense, the eyeglasses can be scanned and removed from inventory and assigned to the patient for purposes of later evaluation and oversight of mission efficacy. This system can have embedded inventory management systems to aid in managing both the current and future inventory needs.

Regarding FIGS. 1-13, alternate configurations of the information can be displayed, as well as additional information included in or removed from any of the tabs, modules, pages, windows, screens, or printouts. Information can be added by selecting radio buttons, using dropdown arrows to select information, checking boxes, entering text, selecting dates from a calendar, auto-inputting information from other databases or windows, or any other desirable method. Basic patient information and buttons can be included as a ribbon to the tabs, which can include additional or less information as displayed in these figures or in another location on the modules. Additionally, the layout of the information can be altered.

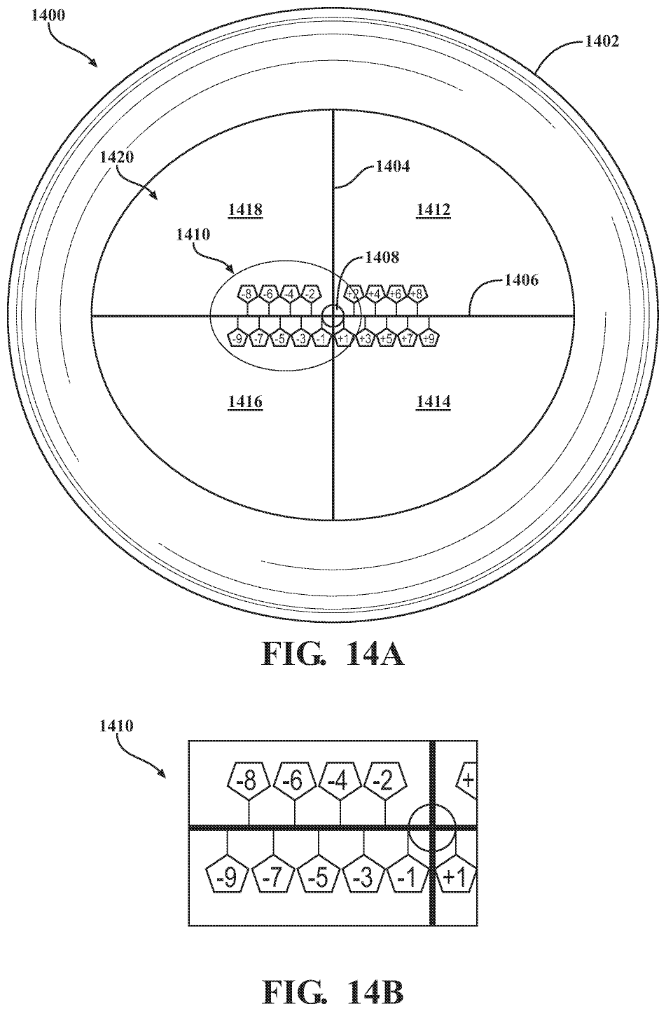

FIGS. 14-21 generally refer to the optical manufacturing system according to this disclosure. In one embodiment, the lenses for eyeglasses come ready to mount from the manufacturer. Much of the excess material has already been removed, or the lenses are initially molded in a specific fashion. Because this happens in a controlled manufacturing environment, locating and spotting (marking up) on the lenses becomes unnecessary.

FIGS. 14a and 14b illustrate a spherical lens mounting decal 1400. An unneeded lens material 1402 may be removed or never added during the lens molding process. A degree axis marker 1404 is along the 90-270 degree axis, or a vertical y axis. A degree axis marker 1406 is along the 0-180 degree axis, or a horizontal x axis. The spherical lens mounting decal 1400 can include a lens optical center 1408 at the center point of a spherical lens 1420. Block decentration markers 1410 are used to facilitate or measure the PD (Pupillary Distance). FIG. 14b is a magnified view of the block decentration markers 1410. Starting at the lens optical center 1408 and going toward the circumference of the spherical lens mounting decal 1400 along axis 1406, block decentration markers 1410 are positive even numbers starting at +2 in a quadrant 1412, positive odd numbers starting at +1 in a quadrant 1414, negative odd numbers starting at −1 in a quadrant 1416, and negative even numbers starting at −2 in a quadrant 1418. Each of the numbers increases or decreases sequentially by 2, wherein the numbers change further from zero.

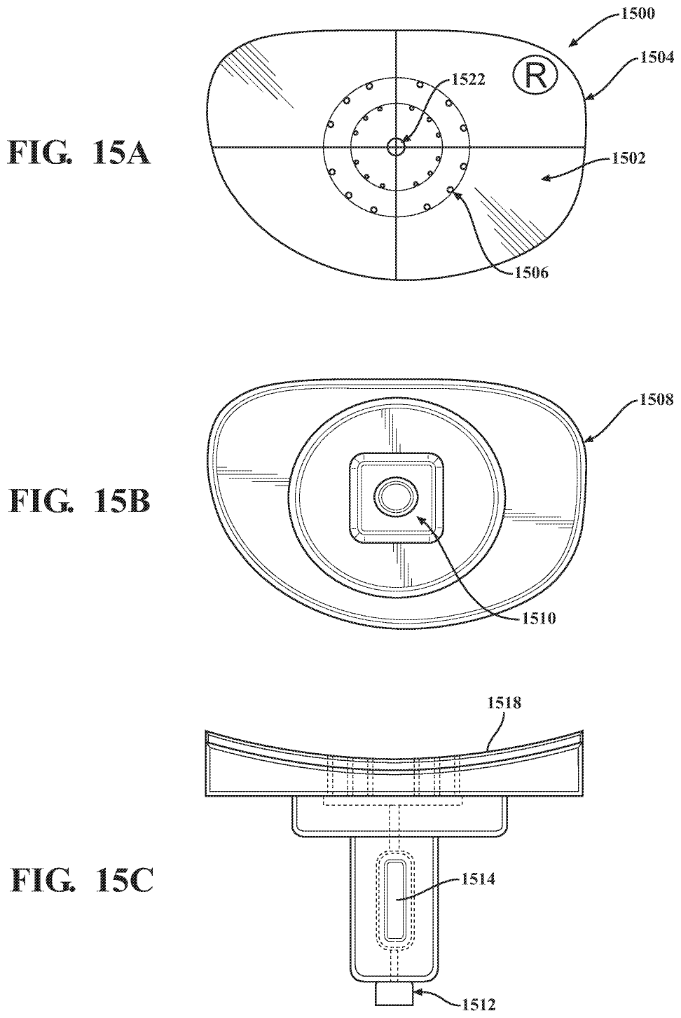

FIGS. 15a-15c illustrate a lens-mounting block 1500. The lens-mounting block 1500 can include a block face 1502 imprinted with an optical center and a 90/180 degree axis for alignment. A lens blank 1504 can be held to the lens-mounting block 1500 by a vacuum suction created through holes 1506, or via adhesive lens-blocking pads. A block shape 1508 can be used instead of traditional patterns. A vacuum attachment 1510 can be used in connection with a release valve 1512. Vacuum cylinder 1514 can include a path for air flow and suction. A concave pliant surface 1518 facilitates alignment of the lens-mounting block 1500 and attachment of the lens via the vacuum suction.

Referring to FIGS. 14a and 15a, the spherical lens alignment can occur when a lens blank 1504 is placed on the axis 1404, 1406 and the lens optical center 1408 and is shifted to the right or to the left to accomplish the appropriate decentration to adjust for the PD based on the frame-specific PD/centering chart as identified in Table 1.

TABLE 1
Frame PD/Centering
SOS Humanity (Men's 54)

| PD | Right | Left |
|---|---|---|
| 58 | −1 | +1 |
| 60 | 0 | 0 |
| 62 | −2 | +2 |
| 64 | −3 | +3 |

In this example, a right lens is produced for a non-astigmatic patient with a PD of 62 for a SOS Humanity Men's 54 frame. As shown in Table 1, when the PD is 58, the shift is to the right is −1 and to the left is +1. At 60 PD, there is no shift, meaning that the lens optical center 1408 aligns with a lens blank center 1522. When the PD is 62, the shift is −2 to the right and +2 to the left. When the PD is 64, the shift is −3 to the right and +3 to the left. When the lens blank 1504 is aligned to the spherical lens 1420, the spherical lens 1420 is vacuum attached to the lens-mounting block 1500.

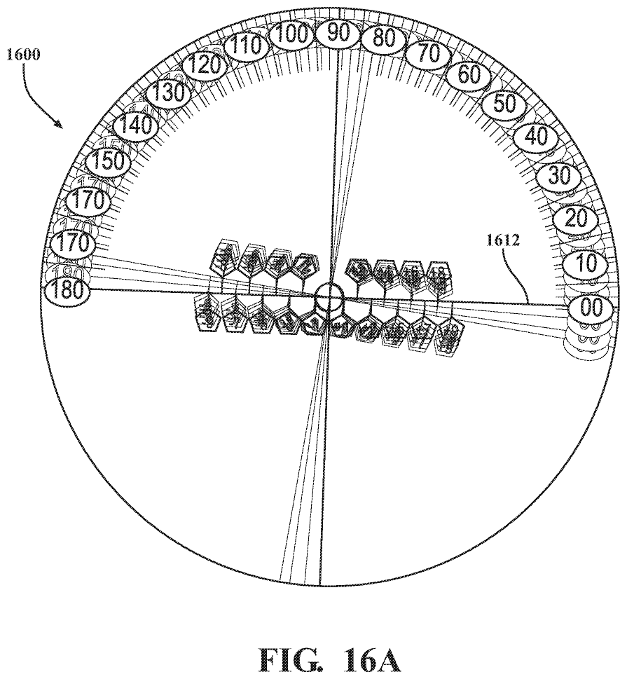

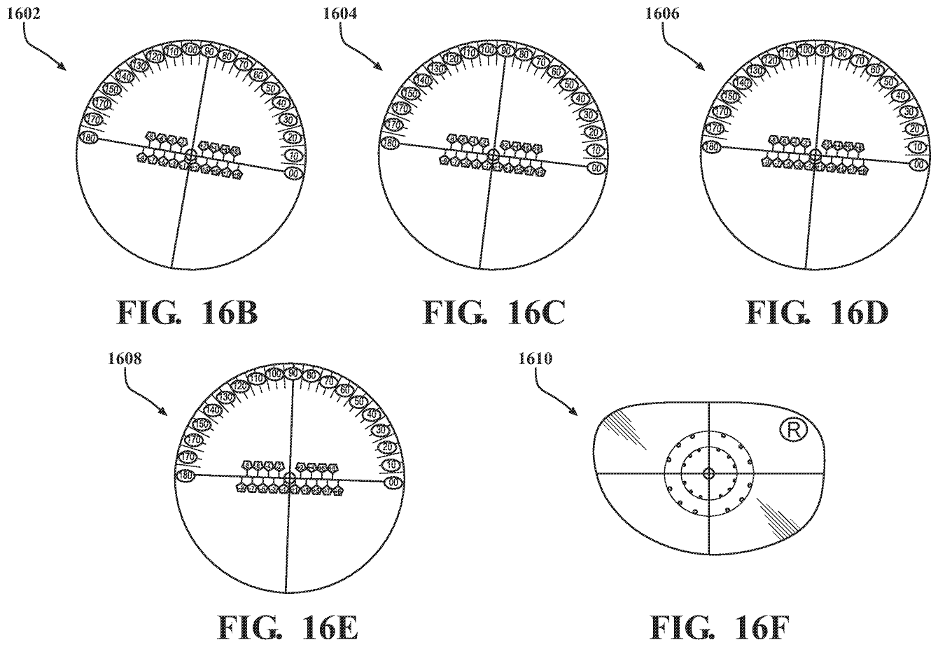

FIGS. 16a-16f illustrate a spherocylindrical (astigmatic) lens alignment 1600. A right lens can be produced for an astigmatic patient, with an axis 1612 of 100 degrees, and with a PD of 62. The frame PD/centering of this illustration can be seen in Table 1 using the SOS Humanity Men's 54 frame. A spherocylindrical lens blank 1610 can be placed on the axis and optical center of the lens-mounting block 1500 and shifted to the right or to the left to accomplish the appropriate decentration to adjust for the PD based on the frame specific PD/centering chart, and then be rotated to the indicator to accomplish the axis of 100 degrees. FIGS. 16b-16e illustrate the rotation of the spherical lens 1420 for this spherocylindrical (astigmatic) lens alignment.

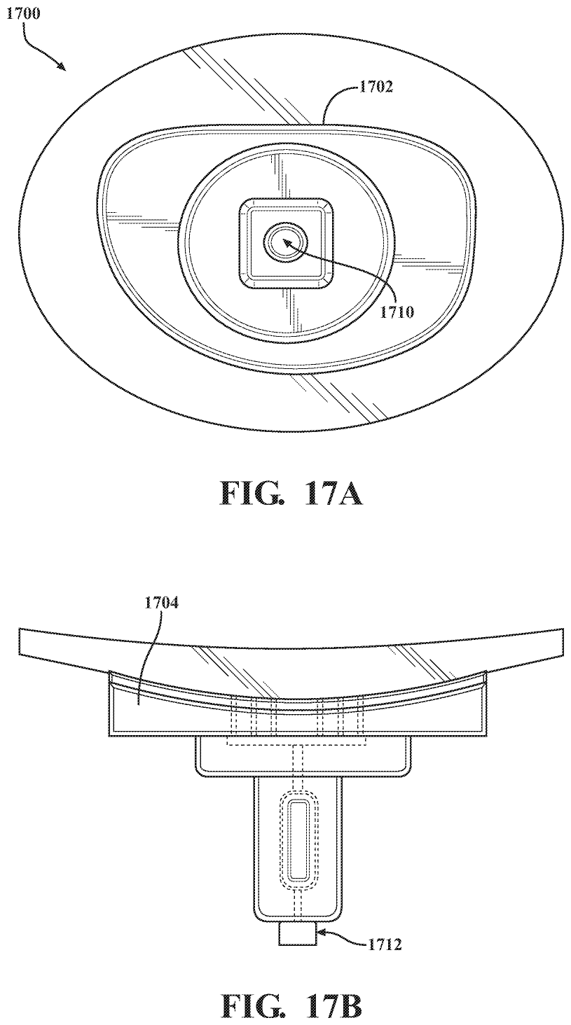

FIGS. 17a and 17b illustrate a lens-mounting block 1700 for the spherocylindrical (astigmatic) lens alignment 1600 of FIG. 16a. Instead of being a pattern, a block shape 1702 can be an edger routing that follows a perimeter of a mounting block 1704. A vacuum attachment 1710 can be used in connection with a release valve 1712. When the edging is complete, the vacuum cylinder, or adhesive pad (if used) can be released.

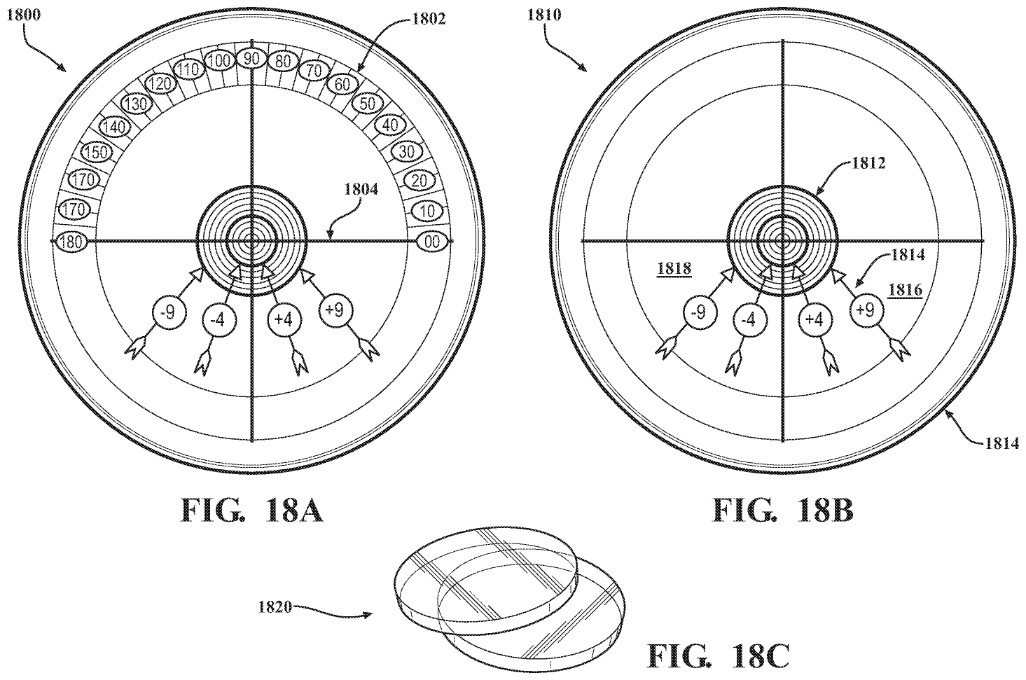

FIGS. 18a and 18b illustrate a lens decal design. A lens decal 1800 can include degree markers 1802 to allow for rotation for a prescribed axis 1804, with rotation from 0 degrees to 180 degrees. The lens decal 1800 can be a spherocylindrical decal or any other desirable shape. A lens decal 1810 can include positioning rings 1812 for centering or decentration to accommodate a patient with PD. As shown in this embodiment, the positioning rings 1812 include centering positions 1814, wherein an outermost centering position is +9 in a quadrant 1816 and −9 in a quadrant 1818 and an inner centering position is +4 in the quadrant 1816 and −4 in the quadrant 1818. The lens decal 1810 can be a spherical decal for non-astigmatic lenses. FIG. 18c is an image of lenses.

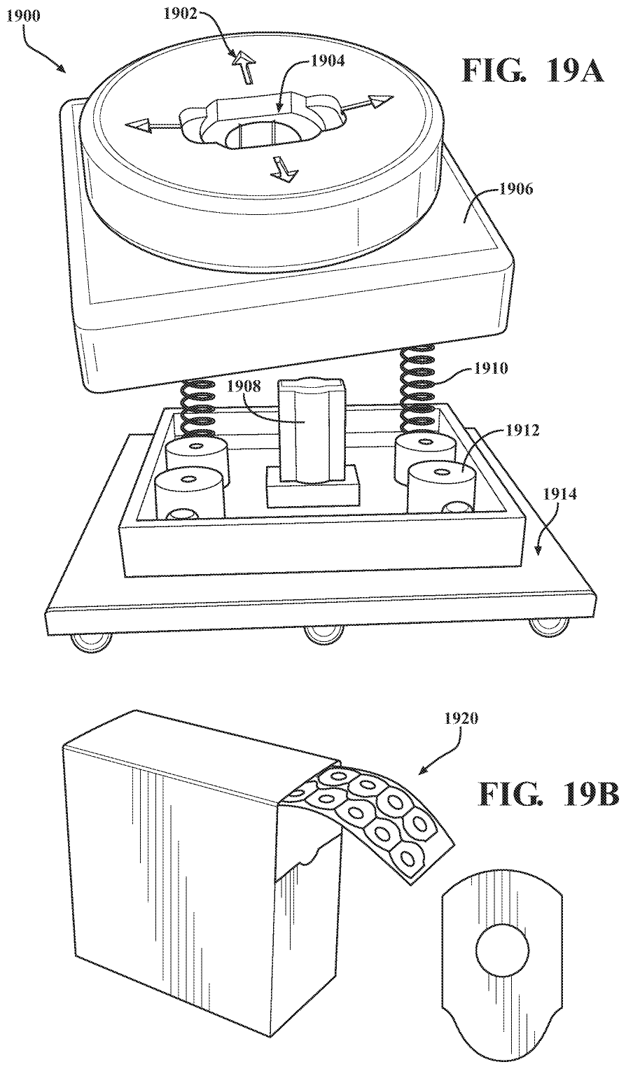

FIG. 19a illustrates a lens blocker machine 1900. A degree position marker 1902 may allow for rotation about a prescribed axis. A mount 1904 may allow for an adhesive strip 1920 as shown in FIG. 19b to be inserted into and used to adhere to a lens. An upper carriage 1906 can mount to a lower carriage 1914 using a guide post screw 1912 and a spring 1910 for manual press to adhere the adhesive operation. A post 1908 can apply pressure to the back of the lens-mounting block 1700 and the adhesive strip 1920 when the lens is positioned and pressed down. The lens blocker 1900 may allow for lens blocking that can also be used in existing traditional manufacturing processes.

The lens blocker machine 1900 works in coordination with the lens decal system as illustrated in FIGS. 18a and 18b. The adhesive strip 1920 and the lens blocker may fit into the inset on the top of the lens blocker machine 1900. The operator of the lens blocker machine 1900 can align the lens onto the lens blocker 1900 using the pre-printed lens decal 1800. Spherocylindrical (astigmatic) lenses can be positioned for both decentration (left or right movement), and rotated to the prescribed axis (degrees of rotation). Spherical (non-astigmatic) lenses can use the less complicated lens decal design and be positioned for decentration. The operator can press down on the lens to push the lens block and adhesive strip 1920 against the lens to adhere it for the next step of edging the lens for the specific frame.

The design of the lens shape and mounting groove of this embodiment is described. The lens shape in the frame should exactly match the lens design for the system to function effectively. Various lens shapes are designed for women, men, children, and unisex frames. For each design, a custom block can be developed for the proper fit. Multiple frames styles and colors by lens shape are possible.

The system and method of this disclosure reduces the need for large numbers of systems and method for creating frames. Based on a sample of optical data, the inventory of frames and lenses can be customized to best fit the spherical and spherocylindrical (astigmatism) needs of a given population; however, as seen in Table 2, a theoretical and fairly robust distribution is equal to 884 lenses in an example region.

TABLE 2

| | | Cyl | Cyl | Cyl | Cyl | Cyl | Cyl |
|---|---|---|---|---|---|---|---|
| Diop- | Spheri- | −.50 | −.75 | −1.00 | −1.50 | −2.00 | −2.50 |
| ters | cal | D | D | D | D | D | D |
| −.75 | 12 | 0 | 4 | 4 | 2 | 0 | 0 |
| −1.00 | 16 | 4 | 6 | 8 | 6 | 2 | 0 |
| −1.50 | 20 | 6 | 8 | 10 | 8 | 4 | 0 |
| −2.00 | 20 | 6 | 8 | 10 | 8 | 4 | 0 |
| −2.50 | 28 | 8 | 10 | 12 | 10 | 6 | 2 |
| −3.50 | 28 | 8 | 10 | 12 | 10 | 6 | 2 |
| −4.00 | 20 | 6 | 8 | 10 | 8 | 4 | 0 |
| −4.50 | 16 | 4 | 6 | 8 | 6 | 2 | 0 |
| −5.00 | 12 | 4 | 6 | 8 | 6 | 2 | 0 |
| +.75 | 8 | 0 | 4 | 4 | 2 | 0 | 0 |
| +1.00 | 12 | 4 | 6 | 8 | 6 | 2 | 0 |
| +1.50 | 16 | 6 | 8 | 10 | 8 | 4 | 0 |
| +2.00 | 16 | 6 | 8 | 10 | 8 | 4 | 0 |
| +2.50 | 20 | 8 | 10 | 12 | 10 | 6 | 2 |
| +3.00 | 20 | 8 | 10 | 12 | 10 | 6 | 2 |
| +4.00 | 16 | 6 | 8 | 10 | 8 | 4 | 0 |
| +4.50 | 12 | 4 | 6 | 8 | 6 | 2 | 0 |
| +5.00 | 8 | 4 | 6 | 8 | 6 | 2 | 0 |

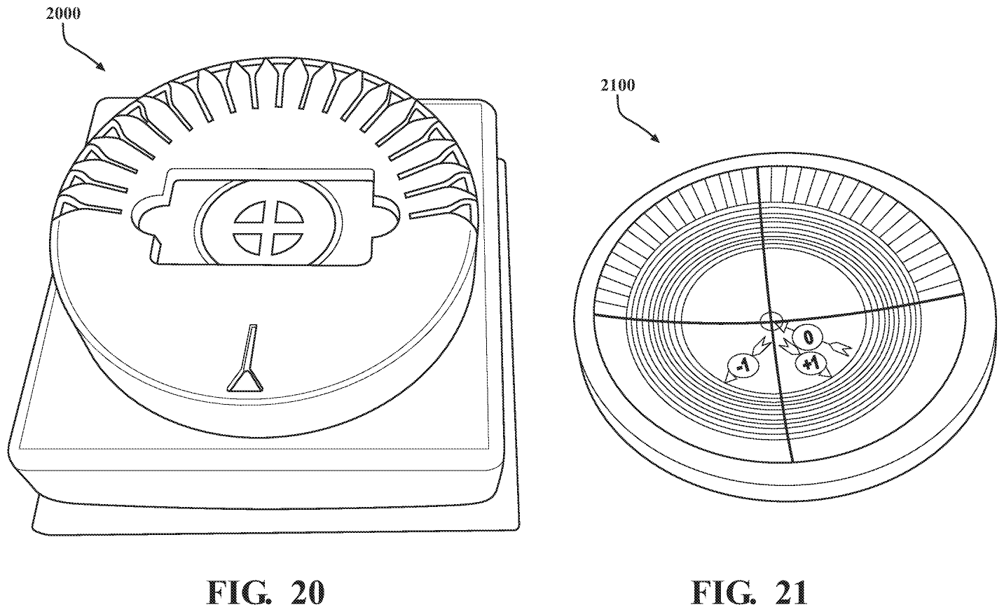

The lens block system and related edger design of this disclosure can be created using a 3D printer or a machinist. The lens decal graphics can be printing using a commercial printer. Various printing and adhesion methods can be implemented. FIGS. 20 and 21 are exemplary embodiments of a lens blocker 2000 and a lens alignment grid 2100.

This process can be implemented via a full scope refractive eye exam, or using handheld autorefractors or mobile device exam options to determine the Rx and appropriate utilization of the inventory. Applications or apps can be used to support and execute the system.

This system can be an integrated system for the selection and distribution or manufacturing of eyeglasses to optically underserved patients. Table 3 is an example of sensitivity settings.

TABLE 3

| SettingID | MstrCylIgnoreMax | MstrCylSphMax | MstrCylDev |
|---|---|---|---|
| 1 | −0.75 | −1.75 | −0.25 |

| Setting Type | Setting ID | MstrCylIgnoreMax | MstrCylSphMax | MstrCylDev |
|---|---|---|---|---|
| Recommended | 1 | −0.75 | −1.75 | −0.25 |
| Acceptable | 2 | −1.00 | −2.00 | −0.50 |
| Not Recommended | 3 | −1.25 | −2.25 | −0.75 |

Based on these sensitivity settings, below are calculations that can be used to determine the specifications of the lenses for a patient and to input the appropriate specifications into the system, for example, into the tab 704 for exam and eyeglass recommendations in the module 700. The spherical equivalent calculation based on the sensitivity settings in Table 3 are as follows:

OSSphEquiv:[RxOSSphere]+([RxOSCyl]/2)

ODSphLowerLimit:

IIf([RxODCyl]>[PatientDataTable(WithMstrSettings)Qry]![MstrCylSphMax],[ODSphEquiv]−[AgeBasedAccomodDiopters],IIf([RxODSphere]=0,[RxODSphere]−[AgeBasedAccomodDiopters],IIf([RxODSphere]<0,[ODSphEquiv]−[AgeBasedAccomodDiopters],IIf([RxODSphere]>0,[ODSphEquiv]−[AgeBasedAccomodDiopters],9999))))

ODSphUpperLimit:

IIf([RxODCyl]>[PatientDataTable(WithMstrSettings)Qry]![MstrCylSphMax],[ODSphEquiv]+[AgeBasedAccomodDiopters],IIf([RxODSphere]=0,[RxODSphere][AgeBasedAccomodDiopters],IIf([RxODSphere]<0,[ODSphEquiv]+[AgeBasedAccomodDiopters],IIf([RxODSphere]>0,[ODSphEquiv]+[AgeBasedAccomodDiopters],9999))))

The spherical OD lens match score is:

Exact Match:

IIf([PMGlassesSelectQry(Step2)]![RxODSphere]=[PreMadeGlassesInventoryTbl]![ODSphere] And [PMGlassesSelectQry(Step2)]![RxODCyl]=[PreMadeGlassesInventoryTbl]![ODCyl] And PMGlassesSelectQry(Step2)]![RxODAxis]=[PreMadeGlassesInventoryTbl]![ODAxis],100,

No Cyl or Cylinder—Spherical Equivalent Match:

IIf([RxODCyl]=0 And [ODCyl]=0,200+Abs(Abs([PMGlasses SelectQry(Step2)]![ODSphEquiv])−Abs([PreMadeGlassesInventoryTbl]![ODSphere])),

Low Cylinder Ignored—Spherical Equivalent Match:

IIf([RxODCyl] Between 0 And [MstrCylIgnoreMax] And [ODCyl]=0,300+Abs(Abs([PMGlassesSelectQry(Step2)]![ODSphEquiv])−Abs([PreMadeGlassesInventoryTbl]![ODSphere])),

Greater Than Low Cylinder & Less Than Cylinder Max—Weighted Spherical Equivalent Match:

IIf([RxODCyl] Between [MstrCylIgnoreMax] And [MstrCylSphMax] And [ODCyl]=0,400+Abs([PMGlassesSelectQry(Step2)]![WSERODSphMaxCalc])−Abs([PreMadeGlassesInventoryTbl]![ODSphere]),999))))

The Weighted Spherical Equivalent Calculation (WSER) is as follows:

WSERODAccomCalc: Determines the percentage weight of Sphere over the combination of the Absolute Sphere over the Combination of the Absolute Sphere plus the Absolute Cylinder, times the Age based Accommodative factor (always 1.0 or less).

IIf([RxODSphere]=0,0,((Abs([RxODSphere]/(Abs([RxODSphere])+Abs([RxODCyl])))))*[AgeBasedAccomodDiopters])

For example: Sphere −2.00, Cylinder −1.00: 2.00/2.00+1.00=0.666666 and 0.666666 times 0.88 (Accommodation of a 30 year old)=0.5866. Thus reducing the relative accommodation based on the level of cylinder.

WSERODSphMinCalc: Determines the minimum Weighted Spherical Equivalent lens based on the WSER Accommodation calculation:

IIf([RxODSphere]=0,0,IIf([RxODSphere]<0,([RxODSphere]−[WSERODAccomCalc])+(([RxODCyl]+[MstrCylDev])/2),IIf([RxODSphere]>0,([RxODSphere]−[WSERODAccomCalc])+(([RxODCyl]+[MstrCylDev]))/2,9999)))

WSERODSphMinCalc: Determines the minimum Weighted Spherical Equivalent lens based on the WSER Accommodation calculation

WSERODSphMaxCalc:

IIf([RxODSphere]=0,0,IIf([RxODSphere]<0,([RxODSphere]+[WSERODAccomCalc])−(([RxODCyl]+[MstrCylDev])/2),IIf([RxODSphere]>0,([RxODSphere]+[WSERODAccomCalc])−(([RxODCyl]+[MstrCylDev]))/2,9999)))

The Weighted Spherical Equivalent Calculation (WSER) based on Table 3 is as follows:

WSERODCylMaxCalc:IIf([RxODCyl]>[MstrCylDev],0,[RxODCyl]+[MstrCylDev])

WSERODCylMinCalc:IIf([RxODCyl]>[MstrCylDev],0,[RxODCyl]−[MstrCylDev])

The SpheroCylindrical OD Lens Match Score is as follows:

Exact Match:

IIf([PMGlassesSelectQry(Step2)]![RxODSphere][PreMadeGlassesInventoryTbl]![ODSphere] And [PMGlassesSelectQry(Step2)]![RxODCyl]=[PreMadeGlassesInventoryTbl]![ODCyl] And [PMGlassesSelectQry(Step2)]![RxODAxis]=[PreMadeGlassesInventoryTbl]![ODAxis],100,

SpheroCylinrical Tolerance/SER Match:

600+Abs([PMGlassesSelectQry(Step2)]![ODSphEquiv]−(([PreMadeGlassesInventoryTbl]![ODSphere]+([PreMadeGlassesInventoryTbl]![ODCyl]/2))))+Abs((([RxODAxis]−[PreMadeGlassesInventoryTbl]![ODAxis])*0.00001)))))

In this example, the parameters are as follows:

### Rx OD Cyl: <[MstrCylIgnoreMax]

### OD Sphere: Between [PMGlassesSelectQry(Step2)]! [ODSphLowerLimit] And [PMGlassesSelectQry(Step2)]![ODSphUpperLimit]

### OD Cyl: Between [RxODCyl]+[MstrCylDev] And [RxODCyl]−[MstrCylDev]

### OD Axis: Between [PMGlassesSelectQry(Step2)]![ODAxisMin] And [PMGlassesSelectQry(Step2)]![ODAxisMax]

The Spherical Equivalent should be in range, and the Axis should be within “X” degrees of range based on the Cyl-Axis Sensitivity Settings (at a Cylinder of −1.00, Axis of 120; the range is from 90 degrees to 150 degrees, while at a Cylinder of −3.00, Axis of 120, the range is from 105 degrees to 135 degrees.

The cylinder/axis range sensitivity settings are shown in Tables 4 and 5.

TABLE 4

| | AxisMatchScore | AxisMatchScore |
|---|---|---|
| Cylinder | Min | Max |
| −0.75 | −6 | 6 |
| −1.00 | −6 | 6 |
| −1.25 | −6 | 6 |
| −1.50 | −6 | 6 |
| −1.75 | −5 | 5 |
| −2.00 | −5 | 5 |
| −2.25 | −4 | 4 |
| −2.50 | −4 | 4 |
| −2.75 | −3 | 3 |
| −3.00 | −3 | 3 |
| −3.25 | −2 | 2 |
| −3.50 | −1 | 1 |
| −3.75 | −1 | 1 |
| −4.00 | 0 | 0 |

TABLE 5

| RxAxis | DegreeOffset | MatchScore |
|---|---|---|
| 119 | 149 | 6 |
| 120 | 90 | −6 |
| 120 | 95 | −5 |
| 120 | 100 | −4 |
| 120 | 105 | −3 |
| 120 | 110 | −2 |
| 120 | 115 | −1 |
| 120 | 120 | 0 |
| 120 | 125 | 1 |
| 120 | 130 | 2 |
| 120 | 135 | 3 |
| 120 | 140 | 4 |
| 120 | 145 | 5 |
| 120 | 150 | 6 |

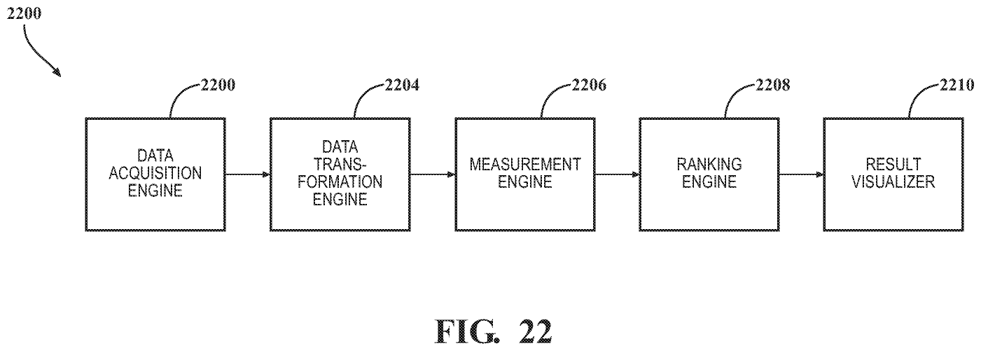

FIG. 22 is a block diagram of the measured results using the computer-implemented systems and methods as described in this disclosure. FIG. 22 illustrates a system 2200 for transforming, measuring, and ranking a patient's eyeglass specifications to available eyeglasses. A data acquisition engine 2202 is an engine that may allow for the manual or data import of patient data. Patient data may include information regarding the patient's demographics, ocular health history, and vision prescription, which can be used to create a dataset. A data acquisition engine 2202 also can allow for the manual or data import of product inventory data via the data acquisition engine 2202. Product inventory data may include the inventory of eyeglasses and eyeglasses assembly components.

In another embodiment, the dataset can include information from databases for the purposes of adding and managing descriptions, attributes, and quantities of various inventory items. For example, the system 2200 can import and synchronize premade eyeglasses, and ready to assemble eyeglass components, along with detailed data elements required by the various processing and selection algorithms. All transaction related inventory decrementation and availability may be handled automatically by the system 2200. The dataset (including patient specific Rx, ocular health information, and eyeglasses provided to the patient) may be exported and shared for research and system development use. The sharing of this information factors into the development of the supply chain and optical ecosystem on a global scale. The data flows from the data acquisition engine 2202 to a data transformation engine 2204.

The data transformation engine 2204 is an engine that can combine the related data components collected in the dataset and perform all of the first level processes to create the dataset required by a measurement engine 2206. Specifically, the data transformation engine 2204 can generate items such as spherical equivalency and other gating criteria such as cylinder power, etc., and convert the data into measurable terms that are used to allow or restrict the use of certain patient to eyeglasses age based accommodative tolerance limits. The data transformation engine 2204 can transform the information into a format for downstream processes. The data flows from the data transformation engine 2204 to a measurement engine 2206.

The measurement engine 2206 is an engine that can combine, compare, and analyze the data prepared by the data transformation engine 2204 that relates to, for example, patient prescription, age, ocular conditions, and available physical product inventory. The measurement engine 2206 can use the processes described above to provide both an optically appropriate solution method and a specific pair of eyeglasses (if product inventory is currently available). The appropriate solution type and pair of eyeglasses may vary, and a dataset of all potential solutions may be generated. Solutions may include one, many, or all of the following solutions for the patient's visual acuity issue or condition: 1) premade eyeglasses that match the patient's needs, 2) assemble on-site eyeglasses that are made up of ready to assemble lens and frame components, and 3) custom made eyeglasses manufactured using traditional optical methods. In some cases based upon the patient's Rx and other ocular health issues, the patient may fall into a medical solutions only category in which the patient is referred out for medical care instead of receiving eyeglasses. The data then flows from the measurement engine 2206 to a ranking engine 2208.

The ranking engine 2208 is an engine that can take the resulting dataset from the measurement engine 2206, apply a weighting factor based on the accuracy tolerance level set by the user for each measure, and output a set of appropriate eyewear solutions in a ranked order. The weighted measures allow the use to establish different assessment magnitudes for each applied measure during a particular measurement session. The accommodative ability of the patient and the resulting predicted visual acuity can be used to determine the relative ranking scores. Each pair of eyeglasses can be ranked based on processes that determine the best possible outcome for the patient based on the available inventory. As fashion is also a component of eyeglasses, the evaluation may include Men's, Women's, or Children's frames, or any combination thereof. Astigmatism may be taken into account using the systems and methods discussed in this disclosure in such a manner that can allow for accommodation to play a larger role in the selection process and expand the usability of the inventory. The ranted results, or ranking results, may be presented to the user in a visual format using a result visualizer 2210. Data flows from the ranking engine 2208 to the result visualizer 2210.

The result visualizer 2210 displays the potential optical solutions for the patient in three basic categories: 1) premade eyeglasses primary pair, 2) premade reading eyeglasses pair (only displayed if add power is prescribed), and 3) assemble on-site eyeglasses (e.g., for primary and reading eyeglasses where appropriate). Essentially, the result visualizer 2210 can display all of the complex results in a format for presenting options to the patient or user, and then selected and dispensed. When a specific solution is selected and dispensed to the patient, the transaction and any necessary adjustments to inventory may be automatically recorded. Additional information may be made available in terms of instructions to the provider on assembly of the assemble on-site eyeglasses or for custom manufacturing when required. The eyeglasses match may be displayed as a number that identifies how closely the eyeglasses match the patient's prescription and specific specifications. The eyeglasses matched are displayed with the best ranked (e.g., lowest resulting number) eyeglasses on top and lesser ranked eyeglasses below or on subsequent pages. For example, an exact prescription match can be scored as 100.0000 for the right lens, plus 100.0000 for the left lens resulting in a displayed score of 200.000. Scores can be segmented into the various types of matching discussed in this disclosure. The system 2200 may include additional and/or fewer steps or processes and is not limited to those illustrated in FIG. 22.

In this specification and in the claims, the use of the article “a,” “an,” or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the items in some embodiments. It will be apparent to one skilled in the art in at least some instances in this specification and the attached claims that it would be possible to include one of the items in at least some embodiments.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A system for the manufacture of eyeglasses, comprising:
a lens-mounting block;
a lens blank coupled to the lens-mounting block;
a lens coupled to the lens blank; and
an edger that follows a perimeter of the lens-mounting block to edge a perimeter of the lens, wherein the lens blank detaches from the lens-mounting block after the lens is edged.

2. The system of claim 1, wherein the lens-mounting block further comprises:
a block face configured to align the lens blank to the lens-mounting block, wherein the block face is imprinted with an optical center and a degree axis.

3. The system of claim 1, wherein the lens blank defines a plurality of holes, and wherein the lens blank is coupled to the lens-mounting block by suction through the plurality of holes.

4. The system of claim 1, wherein the lens blank is coupled to the lens-mounting block by an adhesive lens-blocking pad.

5. The system of claim 1, further comprising:
a vacuum cylinder, wherein the vacuum cylinder includes a path for air flow and suction.

6. The system of claim 1, further comprising:
a vacuum attachment for providing suction between the lens blank and the lens-mounting block; and
a release valve for releasing suction between the lens blank and the lens-mounting block.

7. The system of claim 6, further comprising a concave pliant surface configured to align the lens-mounting block and the lens via the vacuum attachment.

8. The system of claim 1, wherein the lens-mounting block comprises a lens decal.

9. The system of claim 8, wherein the lens decal is a spherocylindrical decal having degree markers.

10. The system of claim 8, wherein the lens decal includes positioning rings for centering or decentration.

11. A method for the manufacture of eyeglasses, comprising:
mounting a lens blank onto a lens-mounting block;
aligning the lens blank having a lens decal design along an axis of the lens-mounting block;
mounting a lens onto the lens-mounting block;
edging a perimeter of the lens based on a perimeter of the lens-mounting block.

12. The method of claim 11, further comprising:
aligning the lens for a pupillary distance (PD) based on specifications of an eyeglass frame; and
rotating the lens using block decentration markers on the lens decal design.

13. The method of claim 11, wherein mounting the lens blank further comprises placing the lens blank on a lens optical center at the center point of the lens; and wherein aligning the lens blank further comprises shifting the lens blank to the right or to the left.

14. The method of claim 11, wherein the axis is a vertical degree axis marker along a vertical axis or a horizontal degree axis marker along a horizontal axis.

15. The method of claim 11, further comprising:
releasing the lens blank from the lens-mounting block when the edging is complete.

16. The method of claim 11, further comprising:
determining specifications of the lens based on a sensitivity setting.

17. A computer-implemented method for the manufacture of eyeglasses, comprising:
receiving, from a computing device, a dataset in a first format;
transforming the dataset into a second format;
evaluating the dataset and computing a score for eyeglasses in the dataset;
ranking eyeglasses by applying a weight factor to the score to create a ranked result set; and
providing the ranked result set to a visualizer.

18. The method of claim 17, wherein the dataset includes at least one of patient data, inventory data, and eyeglass frame data.

19. The method of claim 17, further comprising:
displaying the ranked result set;
receiving an eyeglass selection; and
adjusting inventory data based on the eyeglass selection.

20. The method of claim 17, wherein providing the ranked result set includes providing at least one of premade eyeglasses, assemble on-site eyeglasses, and custom-made eyeglasses.
